(19) United States
(12) Patent Application Publication
(10) Pub. No.: US 2023/0395317 A1
(43) Pub. Date: Dec. 7, 2023

(54) MULTI-COIL INDUCTION APPARATUS

(71) Applicant: Micron Technology, Inc., Boise, ID (US)

(72) Inventors: Timothy Hollis, Meridian, ID (US); David Ovard, Boise, ID (US)

(21) Appl. No.: 18/203,735

(22) Filed: May 31, 2023

Related U.S. Application Data
(60) Provisional application No. 63/348,271, filed on Jun. 2, 2022.

(51) Int. Cl. H01F 27/40; H01F 27/30

(52) U.S. Cl. CPC H01F 27/402; H01F 27/306

(57) ABSTRACT

Systems, methods and apparatus are provided for a multi-coil induction apparatus. The multi-coil induction apparatus has a primary coil structure with a primary first coil portion and a primary second coil portion where both are on a common planar surface; and a secondary coil structure having a secondary first coil portion and a secondary second coil, where the secondary first coil portion and the secondary second coil portion are coplanar with the primary first coil portion and the primary second coil. The primary first coil portion and the secondary first coil portion concentrically turn on the common planar surface to form a coupled induction section while the primary second coil portion and the secondary second coil portion are adjacent the coupled induction section on the common planar surface.

### PRIORITY INFORMATION

This application claims the benefit of U.S. Provisional Application 63/348,271, filed on Jun. 2, 2022, the contents of which are incorporated herein by reference.

### TECHNICAL FIELD

The present disclosure relates generally to integrated circuits, and more particularly to a multi-coil induction apparatus.

### BACKGROUND

For best performance in high-speed integrated circuits, such as graphics double data rate (GDDR) circuits, an induction coil structure, such as a T-coil, is useful to tune out the effects of electrostatic discharge (ESD) and parasitic device capacitance. In spiral inductor designs, the inductance (L) of each sub-coil of the inductance coil and the coupling coefficient (k) are dependent on one another, where it can be challenging to achieve a negative value for a coupling coefficient under certain design constraints.

### BRIEF DESCRIPTION OF THE DRAWINGS

FIG. 1 illustrates a circuit diagram illustrating a multi-coil induction apparatus in accordance a number of embodiments of the present disclosure.

FIG. 2A illustrates a multi-coil induction apparatus in accordance a number of embodiments of the present disclosure.

FIG. 2B illustrates a multi-coil induction apparatus in accordance a number of embodiments of the present disclosure.

FIG. 3 illustrates a block diagram of an apparatus that includes a multi-coil induction apparatus in accordance with a number of embodiments of the present disclosure.

FIG. 4 is a flow diagram corresponding to a method for forming a multi-coil induction apparatus in accordance with a number of embodiments of the present disclosure.

### DETAILED DESCRIPTION

Embodiments of the present disclosure describe a multi-coil induction apparatus. The multi-coil induction apparatus can be used in an integrated circuit, for instance. The multi-coil induction apparatus can include induction coil structures on a common planar surface, where the induction coil structures can provide independent control over each induction value provided by the induction coil structures, which in turn can provide for independent adjustments and optimization of a value of a coupling coefficient and a polarity of the coupling coefficient for the multi-coil induction apparatus. The polarity of the coupling coefficient provided by the induction coil structures on (e.g., positioned on) the common planar surface can have a negative value, which can provide for tuning out the effects of electrostatic discharge (ESD) and/or parasitic device capacitance in high speed parts, such as graphics double data rate (GDDR) circuits.

The present disclosure addresses several issues present in some traditional induction devices. With traditional spiral induction devices, the inductance of each sub-coil of the coil structures and the coupling coefficient are dependent on one another. When attempting to couple two coils of a traditional spiral induction device on, for example, a single metal layer, the two coils would be embedded within each other in a spiral fashion. Such a structure, however, does not provide for an adequate level of control over the coupling coefficient, nor does it provide for significant control and/or variation of both the value and the polarity of the coupling coefficient.

Some other traditional induction coil devices are interleaved. For interleaved induction coil devices, each consecutive loop of the primary inductor coil and the secondary inductor coil passes under the adjacent loop. An issue with this interleaved structure, however, is again a lack of control over the coupling coefficient for the induction coil device, because the coils are in such proximity to each other (e.g., the coils are interleaved and thus essentially completely coupled). Additionally, this structure is generally optimized for equal inductance contributions from both primary and secondary coils, which can be unsuitable for some target applications directed to tuning out parasitic capacitances, which more often are not equally distributed between the three nodes of the coil. This traditional structure also lacks the ability to provide a negative polarity for the coupling coefficient. Further, the structure can repeatedly impinge on the layer below both coils, thereby imposing constraints on anything placed immediate below.

In contrast to the traditional differential induction coil devices previously discussed, the multi-coil induction apparatus of the present disclosure can be used where there are fewer layers on which to form the multi-coil induction apparatus (e.g., one, two or three available layers versus having eight or nine in the traditional differential induction coil devices, as previously discussed). The configuration of the multi-coil induction apparatus of the present disclosure (e.g., on a common planar surface) can also provide for a larger volume of metal to be used for the induction coils structures, as compared to the traditional differential induction coil devices as previously discussed. This is due in part to the ability to confine it to a limited number of the highest metal layers in a semiconductor process, which provides for a reduced resistance of the multi-coil induction apparatus of the present disclosure.

In addition, the multi-coil induction apparatus of the present disclosure provides that each inductance value from the coils in the multi-coil induction apparatus and the value and polarity of the resulting coupling coefficient can be adjusted independently of one another to achieve a desired coupling coefficient (e.g., can provide a negative value for the coupling coefficient). This provides that the multi-coil induction apparatus can be optimized, as compared to the traditional differential induction coil devices as previously discussed, to provide an improved received or transmitted signal quality.

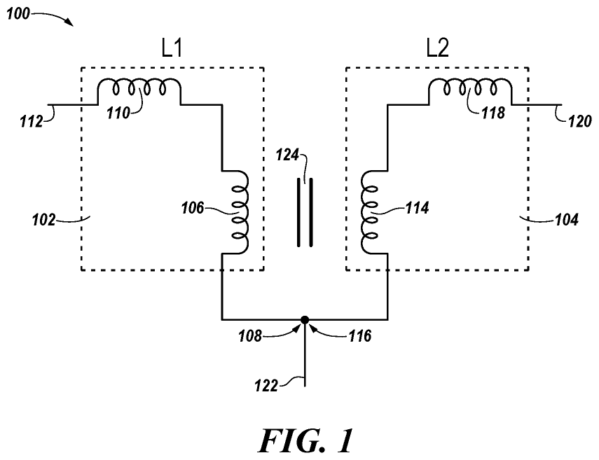

FIG. 1 is a circuit diagram illustrating a multi-coil induction apparatus 100 in accordance a number of embodiments of the present disclosure. As illustrated in FIG. 1, the multi-coil induction apparatus 100 includes a primary coil structure 102 and a secondary coil structure 104. For the various embodiments, the primary coil structure 102 provides a first inductor “L₁” and the second coil structure 104 provides a second inductor “L₂.”

Each of the primary coil structure 102 and the secondary coil structure 104 include a primary coil portion and a secondary coil portion. As illustrated, the primary coil structure 102 includes a primary first coil portion 106 with a primary first coil portion first end 108, and a primary second coil portion 110 with a primary second coil portion second end 112. As discussed herein, both the primary first coil portion 106 and the primary second coil portion 110 are on a common planar surface.

The secondary coil structure 104 has a secondary first coil portion 114 with a secondary first coil portion first end 116 and a secondary second coil portion 118 with a secondary second coil portion second end 120. For the various embodiments, the secondary first coil portion 114 and the secondary second coil portion 118 are coplanar with the primary first coil portion 106 and the primary second coil 110. For the various embodiments, the primary first coil portion first end 108 and the secondary first coil portion first end 116 meet at a center tap 122 for the multi-coil induction apparatus 100.

The configuration of the primary first coil portion 106 and the secondary first coil portion 114 further provide for a coupled induction section (e.g., mutual induction section) 124, which can provide for a mutual inductance in the multi-coil induction apparatus 100. As illustrated, the coupled induction section 124 is formed from the primary first coil portion 106 and the secondary first coil portion 114, which as further discussed herein concentrically turn on the common planar surface to form the coupled induction section 124.

For the various embodiments, the size and number of turns, among other things, in each of the primary first coil portion 106 and the secondary first coil portion 114 can be adjusted independently. These independent adjustments allow for a desired amount and polarity of the mutual induction to be achieved in the coupled induction section 124 and provided at each of the primary second coil portion second end 112, the secondary second coil portion second end 120, and the center tap 122 of the multi-coil induction apparatus 100.

In accordance a number of embodiments of the present disclosure, the primary second coil portion 110 and the secondary second coil portion 118 are positioned adjacent to the coupled induction section 124 on the common planar surface. For the various embodiments, the size, the number of turns along with the proximity of the primary second coil portion 110 and the secondary second coil portion 118 to the coupled induction section 124 can be used to control the mutual inductance produced in the multi-coil induction apparatus 100. As each of the coil portions 106, 110, 114 and 118 of the coil structures 102 and 104 can be independently adjusted (e.g., number of turns, direction of turns and size of coil, among others) there is a wide range of induction values along with polarity choices, as further discussed herein, that are now possible.

As used herein, the number of turns in each of the primary first coil portion 106, the primary second coil portion 110, the secondary first coil portion 114 and the secondary second coil portion 118 can be the same or different. In addition, the number of turns in each of the primary first coil portion 106, the primary second coil portion 110, the secondary first coil portion 114 and the secondary second coil portion 118 need not be integer number but could also include a fraction of a turn (e.g., 1½ turns or 2¼ turns). In accordance with a number of embodiments, the number of turns in each of the primary first coil portion 106, the primary second coil portion 110, the secondary first coil portion 114 and the secondary second coil portion 118 design allows for quarter-turn granularity to achieve a target inductance.

In accordance with a number of embodiments, it is also possible that the inductance from each of the primary coil structure 102 (first inductor “L₁”) and the second coil structure 104 (second inductor “L₂”) can be different even though the number of turns in each of primary coil structure 102 and the second coil structure 104 may be the same (e.g., end up with different induction values from the primary coil structure 102 and the second coil structure 104 without having a different number of turns). This is because the turn radii for each of the primary first coil portion 106, the primary second coil portion 110, the secondary first coil portion 114 and the secondary second coil portion 118 can, independently, be the same or different. Such flexibility in coil radii allows for producing the same or different inductance value in the coupled induction section 124. As a result, it is possible for the multi-coil induction apparatus 100 to have an equal number of turns in each of primary first coil portion 106, the primary second coil portion 110, the secondary first coil portion 114 and the secondary second coil portion 118 while being asymmetric.

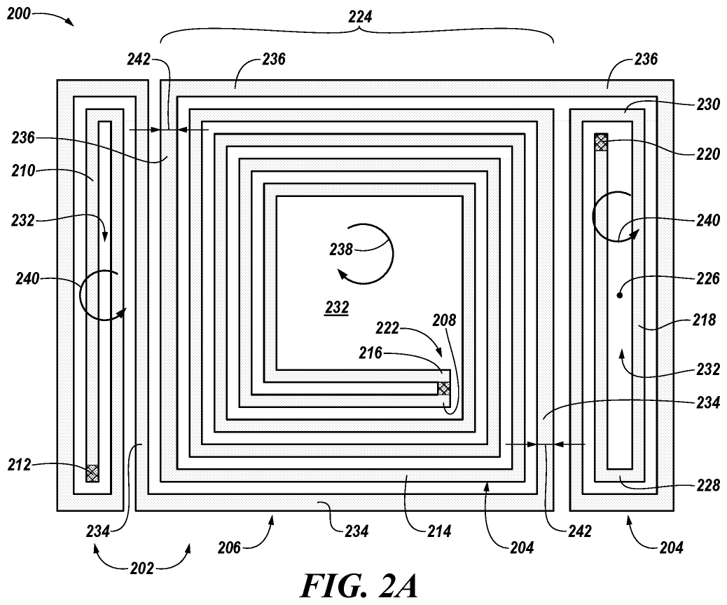

FIGS. 2A and 2B illustrate the multi-coil induction apparatus 200 in accordance a number of embodiments of the present disclosure. FIGS. 2A and 2B provide a perspective view illustrating the multi-coil induction apparatus 200 in accordance with various embodiments of the present disclosure. The multi-coil induction apparatus 200 can include a primary coil structure 202 and a secondary coil structure 204. Each of the primary coil structure 202 and the secondary coil structure 204 can include two (e.g., two separate) coil portions, where the primary coil structure 202 can include a primary first coil portion 206 and a primary second coil portion 210; and the secondary coil structure 204 includes a secondary first coil portion 214 and a secondary second coil portion 218.

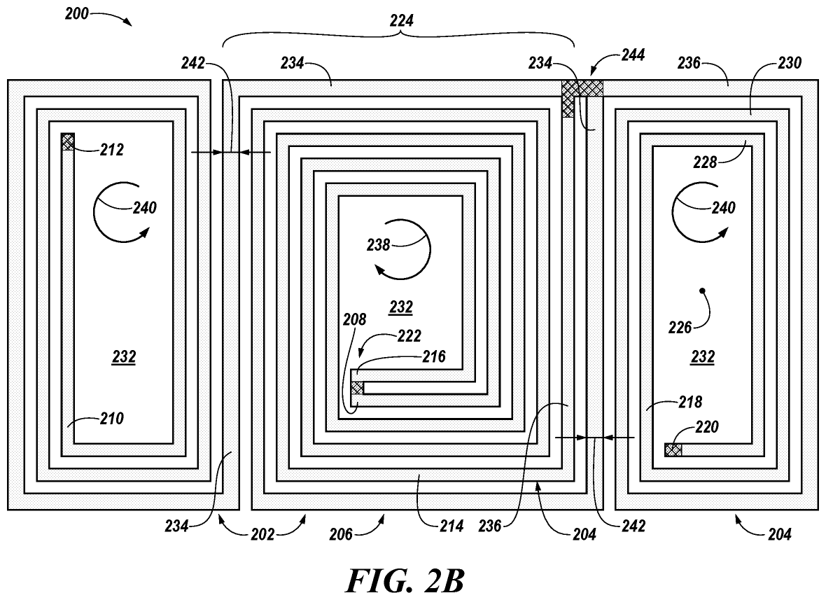

As illustrated in FIGS. 2A and 2B, the primary first coil portion 206 can include a primary first coil portion first end 208 and the primary second coil portion 210 can include a primary second coil portion second end 212. The secondary first coil portion 214 can include a secondary first coil portion first end 216 and the secondary second coil portion 218 can include a secondary second coil portion second end 220. For the various embodiments, each of the primary first coil portion first end 208, the primary second coil portion second end 212, the secondary first coil portion first end 216 and the secondary second coil portion second end 220 can be referred to as a port for the multi-coil induction apparatus 200. As used herein, a port refers to a terminal that can connect to an electrical network and/or integrated circuit (e.g., as a point of entry or exit for electrical energy), an example of which is seen and discussed with respect to FIG. 3, below.

For the various embodiments, the multi-coil induction apparatus 200 can include a center tap 222. The center tap 222 can include the primary first coil portion first end 208 and the secondary first coil portion first end 216. The center tap 222 can be located at a center of the primary first coil portion 206 and the secondary first coil portion 214, for instance. One or more embodiments provide that each of the primary first coil portion 206 and the secondary first coil portion 214 can be symmetrical (e.g., symmetrical coils), that provide an induction value (L) in which each of the primary first coil portion 206 and the secondary first coil portion 214 provides an approximately equal number of turns in a coupled induction section 224 of the multi-coil induction apparatus 200. The present disclosure, however, is not so limited. For example, the center tap 222 for the multi-coil induction apparatus 200 can be asymmetrically located along the primary first coil portion 206 and the secondary first coil portion 214 such that the number of turns for the primary first coil portion 206 and the secondary first coil portion 214 are different (e.g., not approximately equal in number) and therefor provide for an induction value (L) from each of the primary first coil portion 206 and the secondary first coil portion 214 that contributes unequally to a value of the coupling coefficient from the coupled induction section 224 of the multi-coil induction apparatus 200.

As used herein, a “turn” refers to a formation that includes an electrically conductive material (e.g., aluminum, copper, or silver), which is deposited on a substrate (e.g., a redistribution layer) using known deposition techniques, for instance, in a pattern that revolves or moves around a central point (e.g., 226) while receding from or approaching the central point. As illustrated in FIGS. 2A and 2B, a turn (e.g., one turn around center point 226) is shown between element numbers 228 and 230 in secondary second coil portion 218, where a turn is achieved when the electrically conductive material completes a 360 degree path around the central point of the respective coil (e.g., 226 of the secondary second coil portion 218). In the example illustrated in FIG. 2B the primary first coil portion 206 and the secondary first coil portion 214 each have approximately 2.5 turns, while the primary second coil portion 210 and the secondary second coil portion 218 each have approximately 2.75 turns.

For the various embodiment, both the primary first coil portion 206 and the primary second coil portion 210 can be on a common planar surface 232. As used herein, a planar surface is a flat (e.g., two dimensional) surface in which if any two points on the planar surface are chosen, a straight line joining them lies wholly on that planar surface. For the various embodiments, the secondary first coil portion 214 and the secondary second coil portion 218 can be coplanar with the primary first coil portion 206 and the primary second coil portion 210. As used herein, coplanar refers to lying on a same common planar surface (e.g. common planar surface 232). In other words, each of the primary first coil portion 206, the primary second coil portion 210, the secondary first coil portion 214 and the secondary second coil portion 218 all are on the common planar surface 232.

For the various embodiments, the primary second coil portion 210 and the secondary second coil portion 218 can be adjacent the coupled induction section 224 on the common planar surface 232. As illustrated in FIGS. 2A and 2B, the primary second coil portion 210 can be in an area on the common planar surface 232 that is on the opposite side of the secondary second coil portion 218, so that the coupled induction section 224 is located between the primary second coil portion 210 and the secondary second coil portion 218, for instance. In addition, as illustrated in FIGS. 2A and 2B a perimeter of the multi-coil induction apparatus 200 (e.g., as provided by coil portions 206, 208, 210 and 212) can define a quadrilateral shape (e.g., a rectangular) due in part to the linear segments of the coils portions that transition at orthogonal corners to form each of the turns. However, coil portions 206, 208, 210 and 212, as provided herein, can have other shapes and combinations of shapes that form the turns, as discussed herein. For example, at least a portion of one or more of the coil portions 206, 208, 210 and 212 can be a continuous curve (e.g., no orthogonal corners). For the various embodiments, one or more of the coil portions 206, 208, 210 and 212 can be a continuous curve. Other shapes for the coil portions 206, 208, 210 and 212 are possible (e.g., octagonal, among others).

For the various embodiments, the primary coil structure 202 can include a primary coil structure connector portion 234 on the common planar surface 232, where the primary coil structure connector portion 234 electrically couples the primary first coil portion 206 and the primary second coil portion 210. The secondary coil structure 204 can include a secondary coil structure connector portion 236 that electrically couples the secondary first coil portion 214 and the secondary second coil portion 218.

For the various embodiments, the primary first coil portion 206 and the secondary first coil portion 214 can concentrically turn on the common planar surface 232 to form the coupled induction section 224, which can include the center tap 222 with the primary first coil portion first end 208 and the secondary first coil portion first end 216. For example, the primary first coil portion 206 and the secondary first coil portion 214 of the coupled induction section 224 can both concentrically turn in a same first direction 238 to provide the coupled induction section 224 with a coupling coefficient having a negative value. Alternatively, the primary first coil portion 206 and the secondary first coil portion 214 can both turn in opposite directions to provide a coupling coefficient having a positive value for the multi-coil induction apparatus 200 (e.g., from a current flowing through the primary coil structure 202 and the secondary coil structure 204). The value of the coupling coefficient can be adjusted based, at least in part, on the number of turns provided by each of the primary first coil portion 206 and the secondary first coil portion 214 (e.g., the induction value provided by each of the primary first coil portion 206 and the secondary first coil portion 214).

As illustrated in FIGS. 2A and 2B, the primary second coil portion 210 and the secondary second coil portion 218, in contrast to the primary first coil portion 206 and the secondary first coil portion 214, turn in a second direction 240 that is opposite the first direction 238 of the primary first coil portion 206 and the secondary first coil portion 214. Given their proximity to the coupled induction section 224, the induction value provided by each of the primary second coil portion 210 and the secondary second coil portion 218 can be used to independently adjust the value of the coupling coefficient provided in the coupled induction section 224. For the various embodiments, the primary second coil portion 210 and the secondary second coil portion 218 can both turn non-concentrically. In other words, the primary second coil portion 210 and the secondary second coil portion 218 are not positioned next to each other, except for the portion 236 of the secondary coil structure connector portion 236 that is non-planar to the common planar surface 232.

For the various embodiments, the coupled induction section 224 of the multi-coil induction apparatus 200 can provide a negative polarity to the coupling coefficient as the primary first coil portion 206 is embedded with the secondary first coil portion 214 to provide the coupling polarity (e.g., negative). Adjusting a ratio of the primary first coil portion 206 and the secondary first coil portion 214 to the primary second coil portion 210 and the secondary second coil portion 218, as provided herein, can adjust the mutual coupling factor value. This can provide a “fine” tuning of the mutual coupling factor value for the multi-coil induction apparatus 200. In other words, the present disclosure provides for modulation of both the coupled induction section 224 and each of the primary second coil portion 210 and the secondary second coil portion 218 to provide inductance values, coupling coefficient, and the polarity of the coupling coefficient concurrently.

For example, each of the primary first coil portion 206 and the secondary first coil portion 214, as illustrated in FIGS. 2A and 2B, has a first number of turns (e.g., an approximately equal number of turns), whereas each of the primary second coil portion 210 and the secondary second coil portion 218 has a second number of turns that is different than the first number of turns. For one or more embodiments the second number of turns can be less than the first number of turns. Alternatively, for one or more embodiments the second number of turns can be greater than the first number of turns. For one or more embodiments the second number of turns can be equal to the first number of turns. For one or more embodiments, the difference in the first number of turns as compared to the second number of turns can be used to independently adjust the value of the coupling coefficient provided in the coupled induction section 224. For example, a ratio of the first number of turns to the second number of turns can be used to represent this difference, where the selection of the ratio provides control of the mutual coupling factor value for the multi-coil induction apparatus 200 when current flows through the primary coil structure 202 and the secondary coil structure 204. For one or more embodiments in which the primary first coil portion 206 and the secondary first coil portion 214 has a first number of turns, and the primary second coil portion 210 and the secondary second coil portion 218 have a second number of turns that is different than the first number of turns, the ratio (e.g., first number of turns: second number of turns) can be 2:1 to 1:2; 1.5:1 to 1:1.5; 1.2:1 to 1:1.2 or 1.1:1 to 1:1.1, for instance. As illustrated in FIG. 2B, the ratio of the first number of turns to the second number of turns can be approximately 1:1.1. Other ratios are possible.

In one or more embodiments, each of the primary first coil portion 206 and the secondary first coil portion 214, as illustrated in FIGS. 2A and 2B, can have a first number of turns (e.g., an approximately equal number of turns), whereas each of the primary second coil portion 210 and the secondary second coil portion 218 can have a number of turns that is different from the first number of turns and from each other (e.g., the number of turns of the primary second coil portion 210 is different than the number of turns of the secondary second coil portion 218). For example, the primary second coil portion 210 can have a second number of turns and the secondary second coil portion 218 can have a third number of turns, where a first ratio of the first number of turns to the second number of turns and a second ratio of the first number of turns to the third number of turns controls the mutual coupling factor value when current flows through the primary coil structure 202 and the secondary coil structure 204 of the multi-coil induction apparatus. For the various embodiments, the first ratio (e.g., first number of turns: second number of turns) and the second ratio (e.g., first number of turns: third number of turns) can independently be 2:1 to 1:2; 1.5:1 to 1:1.5; 1.2:1 to 1:1.2 or 1.1:1 to 1:1.1, among others.

For one or more embodiments, the line width and line thickness of the primary coil structure 202 and the secondary coil structure 204 can be provide particular resistivity values and/or induction values. For example, the line thickness of the primary coil structure 202 and the secondary coil structure 204 can be equal. In an alternative embodiment, the line thicknesses of the primary coil structure 202 and the secondary coil structure 204 can be different, where it is possible to have the two coils with different thickness when, for example, they might be embodied on different metal layers. Line thickness values for the recited coils 206, 208, 210 and 212 can range, for example, from 1 μm to 4 μm. Other thicknesses are possible.

The line width of the primary coil structure 202 and the secondary coil structure 204 can be approximately the same along the line length. In one or more embodiments, the line width can change at one or more locations of the primary coil structure 202 and/or the secondary coil structure 204 (e.g., be wider in some locations and thinner in other locations). For example, portions of the primary coil structure 202 and the secondary coil structure 204 where relatively lower coupling can occur can be wider than other portions of the coil structures 204 and 206 where relatively higher levels of coupling can occur. An embodiment of this example is illustrated in FIGS. 2A and 2B, where the line thickness in the areas shown by element number 242 is wider than the line thickness in the other areas of the coil structures 204 and 206.

FIG. 2B illustrates a multi-coil induction apparatus 200 in accordance with an additional embodiment of the present disclosure, where the structures and elements described above are identical to those provided in FIGS. 2A and 2B. FIG. 2B, however, provides for an embodiment in which a non-planar portion of the secondary coil structure connector portion 236, seen at element 244, leaves the common planar surface 232 to physically and electrically pass around the primary coil structure connector portion 234 before returning to the common planar surface 232. This structure can take the form of a jumper structure, as are known in the art.

For the various embodiments, the multi-coil induction apparatus 100/200 can be part of an apparatus, such as a computing system (e.g., an integrated circuit (IC)) to improve circuit performance by providing electrostatic discharge protection and/or reducing high frequency signal loss in the IC.

FIG. 3 illustrates a block diagram of an apparatus 350 that includes a multi-coil induction apparatus 300 in accordance with a number of embodiments of the present disclosure. FIG. 3 provides an example of an apparatus 350 that can include at least the multi-coil induction apparatus 100/200, as described herein, where the center tap of the multi-coil induction apparatus 100/200 can, by way of example, be connected to an electrostatic discharge (ESD) device 352. For the various embodiments, the ESD device 252 can include diodes, however, the ESD device 252 is not limited to just diodes.

The apparatus 350 can further include a controller 354, such as a memory controller (e.g., a host controller). Controller 354 might include a processor, for example. Controller 354 might be coupled to a host, for example, and may receive command signals (or commands), address signals (or addresses), and data signals (or data) from the host and may output data to the host.

For the various embodiments, the apparatus 350 can have an input node 356 and output node 358 that can receive signals from the controller 354 and provide signals (e.g., high frequency signals via primary second coil portion second end and the secondary second coil portion second end of 100/200) to an input/output device 360. The input/output device 360 can be an input/output device within the apparatus 350 that is configured to receive an external high frequency signal as an input/output. Input/output device 360 can be coupled to additional input/output circuitry within the IC. Additional input/output circuitry represents additional devices or circuitry that can be coupled to input/output device 360 for processing the input/output signal received via input node 356.

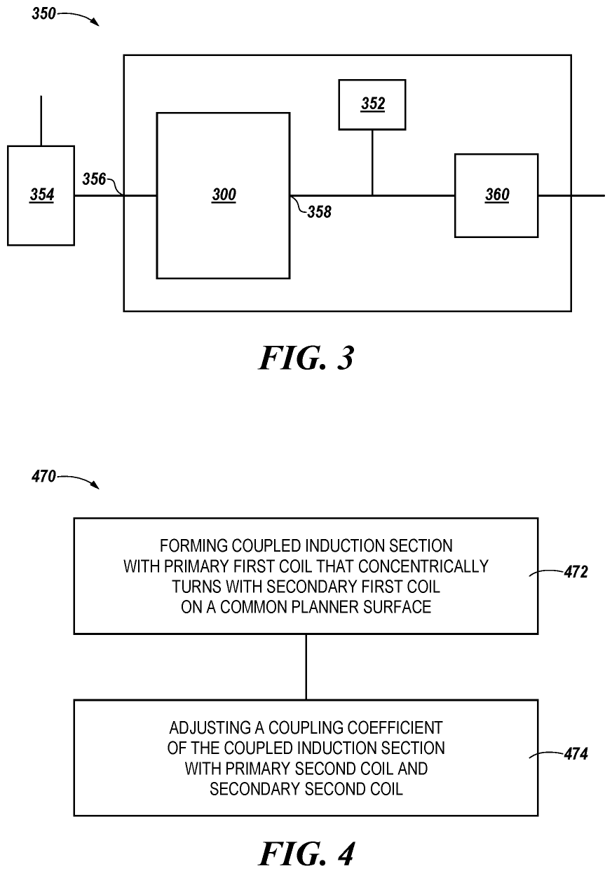

FIG. 4 is a flow diagram corresponding to a method 470 for forming a multi-coil induction apparatus in accordance with a number of embodiments of the present disclosure. The method 470 can include at 472 forming a coupled induction section, as provided herein, with a primary first coil portion that concentrically turns with a secondary first coil portion on a common planar surface. For one or more embodiments, forming the coupled induction section can include forming a first number of turns for both the primary first coil portion and the secondary first coil, where the first number of turns concentrically turn in a same first direction to provide a negative polarity to the coupling coefficient.

The method 470 can further include at 474 adjusting a coupling coefficient of the coupled induction section with the primary second coil portion on the common planar surface and the secondary second coil portion on the common planar surface, as provided herein. For example, adjusting the coupling coefficient of the coupled induction section can include forming a second number of turns for both the primary second coil portion and the secondary second coil, where the second number of turns turn in a second direction opposite the first direction. For one or more embodiments, adjusting the coupling coefficient of the coupled induction section can include setting a ratio, as provided herein, of the second number of turns relative to the first number of turns.

In one or more embodiments, adjusting the coupling coefficient of the coupled induction section can include forming a second number of turns for the primary second coil portion and forming a third number of turns for the secondary second coil, as provided herein, where the second number of turns and the third number of turns both turn in a second direction opposite the first direction. In such embodiments, adjusting the coupling coefficient of the coupled induction section can include setting a first ratio of the second number of turns relative to the first number of turns and a second ratio of the third number of turns relative to the first number of turns, as provided herein.

As provided herein, the primary second coil portion and the secondary second coil portion can be adjacent the coupled induction section on the common planar surface. Accordingly, the method 470 can include forming the primary second coil portion of the primary coil structure can be on a first area on the common planar surface and forming the secondary second coil portion of the secondary coil structure can be on a second area on the common planar surface, where the first area and the second area are adjacent to the coupled induction section.

Although shown in a particular sequence or order, unless otherwise specified, the order of the methods can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The figures herein follow a numbering convention in which the first digit or digits correspond to the drawing figure number and the remaining digits identify an element or component in the drawing. Similar (e.g., the same) elements or components between different figures may be identified by the use of similar digits. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate the embodiments of the present disclosure and should not be taken in a limiting sense.

As used herein, “a number of” or a “quantity of” something can refer to one or more of such things. For example, a number of or a quantity of turns can refer to one or more turns. A “plurality” of something intends two or more. As used herein, multiple acts being performed concurrently refers to acts overlapping, at least in part, over a particular time period. As used herein, the term “coupled” may include electrically coupled, directly coupled, and/or directly connected with no intervening elements (e.g., by direct physical contact), indirectly coupled and/or connected with intervening elements, or wirelessly coupled. The term coupled may further include two or more elements that co-operate or interact with each other (e.g., as in a cause and effect relationship). An element coupled between two elements can be between the two elements and coupled to each of the two elements. Unless stated otherwise, where a single element is discussed, it is understood that all similar elements are referred to.

It should be recognized the term planar accounts for variations from “exactly” planar due to routine manufacturing, measuring, and/or assembly variations and that one of ordinary skill in the art would know what is meant by the term “planar.”

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

What is claimed is:

1. A multi-coil induction apparatus, comprising:
a primary coil structure having a primary first coil portion with a primary first coil portion first end and a primary second coil portion with a primary second coil portion second end, wherein both the primary first coil portion and the primary second coil portion are on a common planar surface; and
a secondary coil structure having a secondary first coil portion with a secondary first coil portion first end and a secondary second coil portion with a secondary second coil portion second end, wherein the secondary first coil portion and the secondary second coil portion are coplanar with the primary first coil portion and the primary second coil;
wherein the primary first coil portion and the secondary first coil portion concentrically turn on the common planar surface to form a coupled induction section having a center tap with the primary first coil portion first end and the secondary first coil portion first end, and
wherein the primary second coil portion and the secondary second coil portion are adjacent the coupled induction section on the common planar surface.

2. The multi-coil induction apparatus of claim 1, wherein the primary first coil portion and the secondary first coil portion of the coupled induction section both concentrically turn in a first direction to provide a coupling coefficient having a negative value.

3. The multi-coil induction apparatus of claim 2, wherein the primary second coil portion and the secondary second coil portion turn in a second direction that is opposite the first direction of the primary first coil portion and the secondary first coil.

4. The multi-coil induction apparatus of claim 3, wherein each of the primary first coil portion and the secondary first coil portion has a first number of turns.

5. The multi-coil induction apparatus of claim 4, wherein each of the primary second coil portion and the secondary second coil portion has a second number of turns that is different than the first number of turns, wherein a ratio of the first number of turns to the second number of turns controls a mutual coupling factor value for the multi-coil induction apparatus when current flows through the primary coil structure and the secondary coil structure.

6. The multi-coil induction apparatus of claim 5, wherein the second number of turns is greater than the first number of turns.

7. The multi-coil induction apparatus of claim 4, wherein the primary second coil portion has a second number of turns and the secondary second coil portion has a third number of turns, wherein a first ratio of the first number of turns to the second number of turns and a second ratio of the first number of turns to the third number of turns controls a mutual coupling factor value when current flows through the primary coil structure and the secondary coil structure of the multi-coil induction apparatus.

8. The multi-coil induction apparatus of claim 1, wherein the primary coil structure includes a primary coil structure connector portion on the common planar surface, wherein the primary coil structure connector portion electrically couples the primary first coil portion and the primary second coil.

9. The multi-coil induction apparatus of claim 8, wherein the secondary coil structure includes a secondary coil structure connector portion that electrically couples the secondary first coil portion and the secondary second coil, wherein at least a portion of the secondary coil structure connector portion is non-planar to the common planar surface.

10. An apparatus, comprising:
a multi-coil induction apparatus comprising:
a primary coil structure having a primary first coil portion with a primary first coil portion first end, a primary second coil portion with a primary second coil portion second end and a primary coil structure connector portion that electrically couples the primary first coil portion and the primary second coil, wherein the primary first coil portion, the primary second coil portion and the primary coil structure connector portion are on a common planar surface; and
a secondary coil structure having a secondary first coil portion with a secondary first coil portion first end, a secondary second coil portion with a secondary second coil portion second end and a secondary coil structure connector portion that electrically couples the secondary first coil portion and the secondary second coil, wherein both the secondary first coil portion and the secondary second coil portion are on the common planar surface, wherein:
the primary first coil portion and the secondary first coil portion concentrically turn on the common planar surface to form a coupled induction section having a center tap with the primary first coil portion first end and the secondary first coil portion first end, and
wherein the primary second coil portion and the secondary second coil portion are adjacent the coupled induction section on the common planar surface; and
an electrostatic discharge (ESD) device, wherein the center tap is connected to the ESD device.

11. The apparatus of claim 10, wherein the primary first coil portion and the secondary first coil portion of the coupled induction section both concentrically turn in a first direction to provide a coupling coefficient having a negative value for the multi-coil induction apparatus from a current flowing through the primary first coil portion and the secondary first coil.

12. The apparatus of claim 11, wherein the primary second coil portion and the secondary second coil portion both turn in a second direction that is opposite the first direction.

13. The apparatus of claim 12, wherein each of the primary first coil portion and the secondary first coil portion has a first number of turns and wherein each of the primary second coil portion and the secondary second coil portion has a second number of turns that is different than the first number of turns, wherein a ratio of the first number of turns to the second number of turns controls a mutual coupling factor value for the multi-coil induction apparatus when current flows through the primary coil structure and the secondary coil structure.

14. The apparatus of claim 10, wherein the primary first coil portion and the secondary first coil portion both turn in opposite directions to provide a coupling coefficient having a positive value for the multi-coil induction apparatus from a current flowing through the primary first coil portion and the secondary first coil.

15. The apparatus of claim 10, wherein at least the portion of the secondary coil structure connector portion that is non-planar to the common planar surface is adjacent to the primary coil structure connector portion that is on the common planar surface.

16. A method, comprising,
forming a coupled induction section with a primary first coil portion of a primary coil structure that concentrically turns with a secondary first coil portion of a secondary coil structure on a common planar surface, wherein the coupled induction section provides a coupling coefficient; and
adjusting the coupling coefficient of the coupled induction section with a primary second coil portion of the primary coil structure on the common planar surface and a secondary second coil portion of the secondary coil structure on the common planar surface.

17. The method of claim 16, wherein forming the coupled induction section includes forming a first number of turns for both the primary first coil portion and the secondary first coil, wherein the first number of turns concentrically turn in a first direction to provide a negative value for the coupling coefficient.

18. The method of claim 17, wherein adjusting the coupling coefficient of the coupled induction section includes forming a second number of turns for both the primary second coil portion and the secondary second coil, wherein the second number of turns turn in a second direction opposite the first direction.

19. The method of claim 17, wherein adjusting the coupling coefficient of the coupled induction section includes forming a second number of turns for the primary second coil portion and forming a third number of turns for the secondary second coil, wherein the second number of turns and the third number of turns both turn in a second direction opposite the first direction.

20. The method of claim 19, wherein adjusting the coupling coefficient of the coupled induction section includes setting a first ratio of the second number of turns relative to the first number of turns and a second ratio of the third number of turns relative to the first number of turns.
